(19) United States
(12) Patent Application Publication
(10) Pub. No.: US 2004/0255271 A1
(43) Pub. Date: Dec. 16, 2004

(54) Method of changing setting of user setting menu in a mobile terminal

(75) Inventor: Seok-Hun Lim, Suwon-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/757,911

(22) Filed: Jan. 14, 2004

(30) Foreign Application Priority Data
Feb. 6, 2003 (KR) 7493/2003

(51) Int. Cl. G06F 9/44

(52) U.S. Cl. 717/110; 717/101; 717/172

(57) ABSTRACT

A method of automatically changing the setting of user setting menu options at a time in a mobile terminal. A user selects user setting menu options and registers them as setting categories in connection with setting values in a scheduling setting group. A scheduling timer is set to a timing value for providing timing for changing the settings of the selected user setting menu options and activates the scheduling timer when a scheduling setting mode is set. The settings of the user setting menu options are changed to the setting values of the setting categories at the expiration of the scheduling timer.

### PRIORITY

This application claims priority under 35 U.S.C. § 119 to an application entitled “Method of Changing Setting of User Setting Menu in a Mobile Terminal” filed in the Korean Industrial Property Office on Feb. 6, 2003 and assigned Serial No. 2003-7493, the contents of which are incorporated herein by reference.

### BACKGROUND OF THE INVENTION

1. Field of the Invention

The present invention relates generally to a mobile terminal, and in particular, to a method of changing the setting of a user setting menu option in a mobile terminal.

2. Description of the Related Art

A mobile terminal contains various functions that a user can selectively invoke. To make the mobile terminal easier to use, a menu is displayed which contains menu options corresponding to respective functions. Each menu option can be further branched into sub-menu options, each sub-menu option can be branched, and so on. Thus, the menu can be represented in a hierarchical, i.e. as a tree, structure.

Depending on whether a user is allowed to configure his phone preferences, menu options are categorized into two groups. One group is menu options that the user is allowed only to use, for example, Game, Calculator, Memo Pad, Number Search, Last Number Dialed, Last Number Received, etc. The other group is menu options that the user is allowed to set conditionally, for example, Menu Setup, Background Image, Alarm, Alert Type, Tones, Brightness, and Roaming. The setting of a menu option in the second group depends on user selection. If the user selects Alert Type, which has sub-menu options including Ring/Melody, Vibration, Silencing (Only Light), Ring+Vibra, and Vibra+Ring, and then selects Ring/Melody, Alert Type is set to Ring/Melody. This option allows ringer tones or a melody to be played for incoming calls. If the user selects Vibration, Alert Type is set to Vibration. Thus upon incoming of a call, the mobile terminal vibrates. These menus (menu options) that allow the user to configure his phone preference are called “user setting menus (menu options)”.

Conventionally, the user manually changes the setting of user setting menu options. Unless the user manually changes the settings, the user setting menu options are maintained. Accordingly, the user must manage to change the setting manually when necessary. It may occur that the user forgets to change the setting when etiquette requires. For example, the user may bother others at a conference when a call is received and the mobile phone is set in a ring/melody mode, or he may not perceive an incoming call when he is in a noisy street and the mobile phone within a user's bag is set to a vibration mode.

In this context, many phone setting methods have been proposed to allow the user to reserve the settings of user setting menu options according to his schedule, such as Alert Type, Ring Tones and Volume, Connect to Voicemail, and Alarm Type, so that the settings of the user setting menu options are automatically changed. According to these reservation setting methods, if the user decides a setting state for a user setting menu and sets a timer to an intended timing value, the user setting menu is changed to the state as scheduled.

Despite the advantage of automatic changing the settings of the user setting menus as scheduled, the above methods have limitations in adaptively satisfying a variety of user schedules. The user schedule varies by season, at the beginning or end of the month, on holidays, or in week days, etc. Since the settings of the user setting menus are changed only to the decided states and reservation setting is available only to a few predetermined user setting menus and do not allow the user to predetermine scheduling groups of selected user set menu options, the conventional menu setting methods are limited and cannot satisfy user demands.

### SUMMARY OF THE INVENTION

It is, therefore, an object of the present invention to provide a method of allowing a user to select a plurality of user setting menu options and automatically change the settings of the user setting menu options according to his schedule.

It is another object of the present invention to provide a method of automatically changing at a predetermined time the setting values of selected user setting menu options that vary according to a user schedule.

It is a further object of the present invention to provide a method of automatically changing the settings of a plurality of user setting menu options by simple user manipulation, adaptively according to a changed user schedule.

To achieve the above objects, a method is provided of automatically changing the setting of user setting menu options at a predetermined time in a mobile terminal, a user selects user setting menu options and registers them as setting categories in connection with setting values in a scheduling setting group. He sets a scheduling timer to a timing value for providing timing for changing the settings of the selected user setting menu options and activates the scheduling timer when a scheduling setting mode is set. The settings of the user setting menu options are changed to the setting values of the setting categories at the expiration of the scheduling timer.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile terminal to which the present invention is applied;

FIG. 2 is a flowchart illustrating an operation for registering a scheduling setting group according to an embodiment of the present invention;

FIG. 3 illustrates examples of menu displays for registering a scheduling setting group according to the present invention;

FIG. 4 illustrates the structure of a scheduling setting table according to the present invention;

FIG. 5 is a flowchart illustrating an operation for setting a scheduling setting mode according to the present invention;

FIG. 6 illustrates examples of menu displays for scheduling timer registration according to the present invention; and

FIG. 7 is a flowchart illustrating an operation for changing the settings of user setting menu options as scheduled according to the present invention.

### DETAILED DESCRIPTION OF THE PREFERRED EMBODIMENTS

A preferred embodiment of the present invention will be described herein below with reference to the accompanying drawings. In the following description, well-known functions or constructions are not described in detail since they would obscure the invention in unnecessary detail.

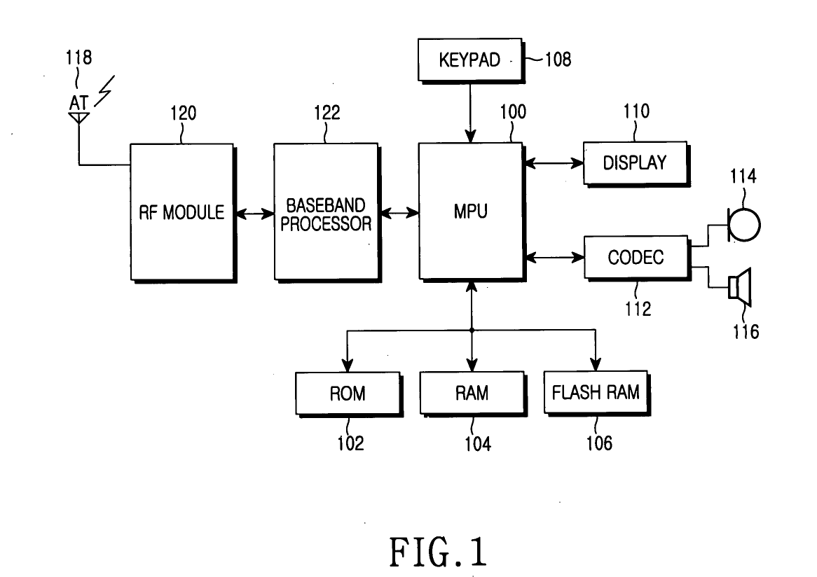

FIG. 1 is a block diagram of a mobile terminal to which the present invention can be applied. Referring to FIG. 1, a microprocessor unit (MPU) 100 changes the setting of a user setting menu according to the present invention as well as performs traditional functions such as processing and control of telephone calls, messages, and data communications. A read only memory (ROM) 102 stores micro-codes for operation and control programs of the MPU 100 and look-up data. A random access memory (RAM) 104 serves as a working memory for the MPU 100. A flash RAM 106 provides an area in which data to be updated is stored. A keypad 108 includes numeric keys 0 to 9, and function keys like *, #, Send, Clear, End, Volume, and softkeys and provides key input data corresponding to a pressed key to the MPU 100. A display 110 visually displays image information received from the MPU 100. A coder-decoder (CODEC) 112 is connected to the MPU 100 and to a microphone 114 and a speaker 116 to provide voice input/output for phone calls and voice recording.

A radio frequency (RF) module 120 transmits/receives RF signals to/from a base station (BS). It modulates a transmission signal received from the MPU 100 and transmits the modulated RF signal through an antenna 118. It also demodulates an RF signal received through the antenna 118 and provides the demodulated signal to the MPU 100 through a baseband processor 122. The baseband processor 122 processes baseband signals exchanged between the RF module 120 and the MPU 100.

According to the present invention, a user freely selects a plurality of user setting menu options according to his schedule, decides their setting values, and registers the user setting menu options as setting categories under a scheduling setting group having a unique identifier (ID). A plurality of scheduling setting groups can be registered when necessary. That is, the user can select different sets of user setting menu options and register each set of user setting menu options under a different scheduling setting group.

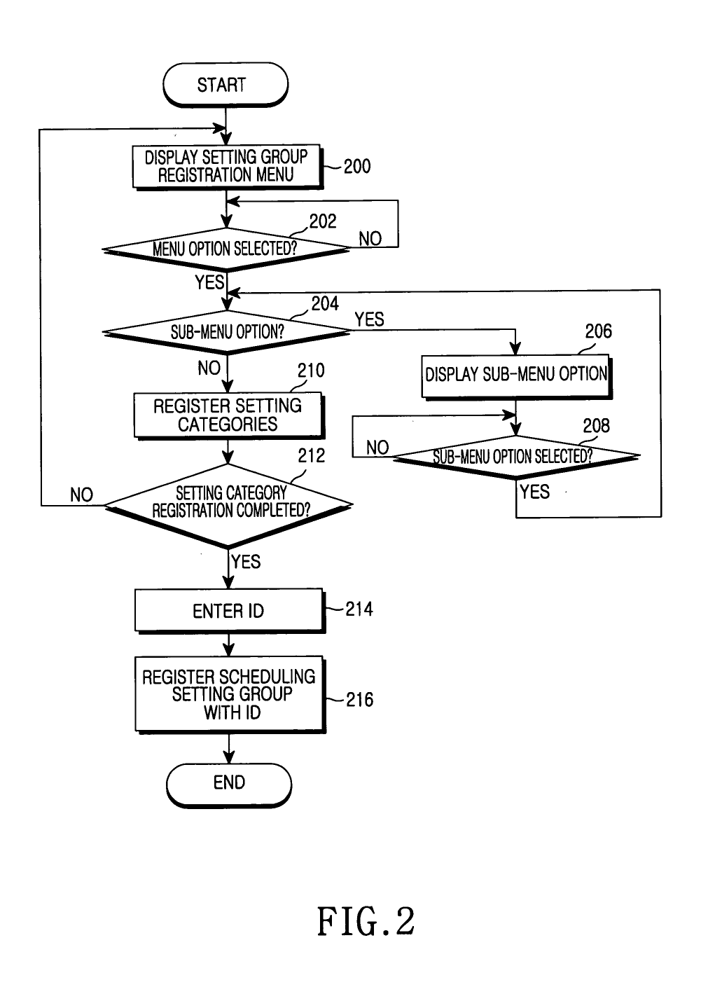

FIG. 2 is a flowchart illustrating an operation in the MPU 100 illustrated in FIG. 1 for registering a scheduling setting group according to an embodiment of the present invention.

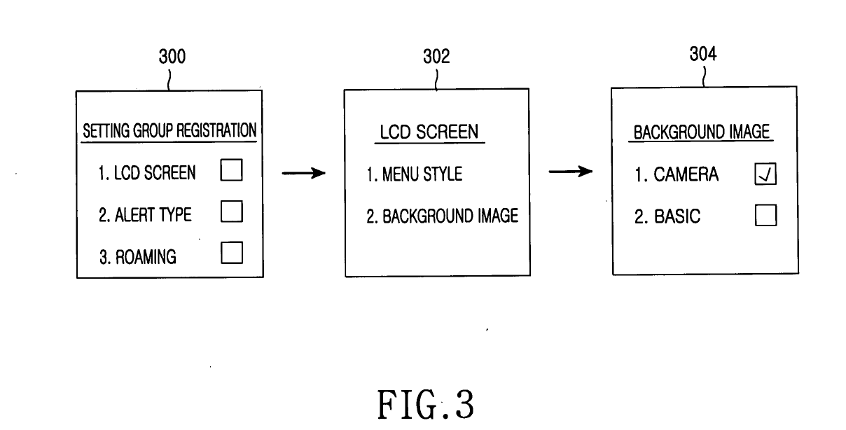

Referring to FIG. 2, when the user selects a Setting Group Registration menu using the keypad 108, the MPU 100 displays the Setting Group Registration menu on the display 110 in step 200 and awaits selection of a menu option in step 202. The Setting Group Registration menu is added to traditional menus provided in the mobile terminal according to the present invention. An example of the Setting Group Registration menu is denoted by reference numeral 300 in FIG. 3. The example Setting Group Registration menu 300 has three menus, LCD Screen, Alert Type, and Roaming. The LCD Screen menu 302 is displayed together with menu options Menu Style and Background Image when the user selects the LCD Screen menu. The Background Image 304 is displayed with sub-menu options Camera and Basic when the user selects Background Image.

If the user selects Camera, a picture taken by a camera (not shown) of the mobile terminal and is displayed as a background image. On the other hand, if the user selects Basic, an image stored in the flash RAM 106 is displayed as the background image.

The Alert Type menu under the Setting Group Registration menu 300 is branched into Ring/Melody, Vibration, Silencing (Only Light), Ring+Vibra, and Vibra+Ring. The Roaming menu is set to On for roaming over a preset mobile communication network. In this example, Camera and Basic under the LCD Screen menu, Ring/Melody, Vibration, Silencing (Only Light), Ring+Vibra, and Vibra+Ring under the Alert Type menu, and On under the Roaming menu are the actual user setting menu options.

When the user selects one of the menu options under the Setting Group Registration menu 300 using the keypad 108 in step 202, the MPU 100 performs steps 204 to 208, or steps 204 to 216 depending on the presence or absence of a sub-menu option under the selected menu option. For example, once the user selects the LCD Screen menu which is further branched, its menu options are displayed as indicated by reference numeral 302 in step 206 and the MPU 100 awaits selection of a sub-menu option in step 208. If the user selects one of the sub-menu options using the keypad 108, the MPU 100 returns to step 204 and then performs step 210 or steps 206 to 208 depending on the presence or absence of a further sub-menu options under the selected sub-menu option.

In the absence of any sub-menu option, the MPU 100 registers the selected ultimate menu option with the selected setting value as a setting category in step 210. For example, if the user selects Camera for Background Image 304, Camera is marked with a check (i.e. “√”) and Background Image is registered together with its setting value indicating Camera as a setting category under a scheduling setting group. According to whether the setting category registration is completed or not in step 212, steps 200 to 208 are repeated or the MPU 100 proceeds to step 214. Upon input of a key for registering another user setting menu as a setting category in the scheduling setting group, steps 200 to 210 are repeated. On the other hand, upon input of a key for completing the setting category registration, step 214 is performed. For example, when a text message is displayed asking whether the scheduling setting group registration is completed, the user presses the Send key if he is to register another user setting menu option as a setting category, or the End key if he wants to complete the registration.

If the user presses the End key, the MPU 100 prompts the user to enter an ID of the registered schedule setting group and receives the ID through the display 110 in step 214. In step 216, the MPU 100 assigns the ID to the scheduling setting group containing setting categories registered in steps 200 to 212 and registers the scheduling setting group as a new one in the flash RAM 106, using its ID as an index.

As described above, the user freely selects some or all of user setting menu options according to his schedule, sets the settings of the selected user setting menu items, and registers them with their setting values as setting categories in a scheduling setting group. If he further registers another scheduling setting group, he follows the same procedure of steps 200 to 216. For example, the user selects user setting menu options the settings of which he wants to change while at home on holidays, and registers them in connection with their setting values in a scheduling setting group with an ID of 1. The user then selects user setting menu options the settings of which he wants to change while at work in his office and registers them in connection with their setting values in another scheduling setting group with an ID of 2. In this manner, differential scheduling setting groups can be produced for respective occasions such as upcoming conference, performance, lecture class, birthday party, etc.

In accordance with the present invention, in view of the menu tree the MPU 100 manages, for each scheduling setting group, registered setting categories with their setting values in a tree structure of main category, sub-category 1, sub-category 2, . . . , that is, in a layered scheduling setting table in the flash RAM 106. The main category corresponds to top menus, sub-category 1 corresponds to menu options for the top menus, and sub-category 2 corresponds to sub-menu options for the menu options.

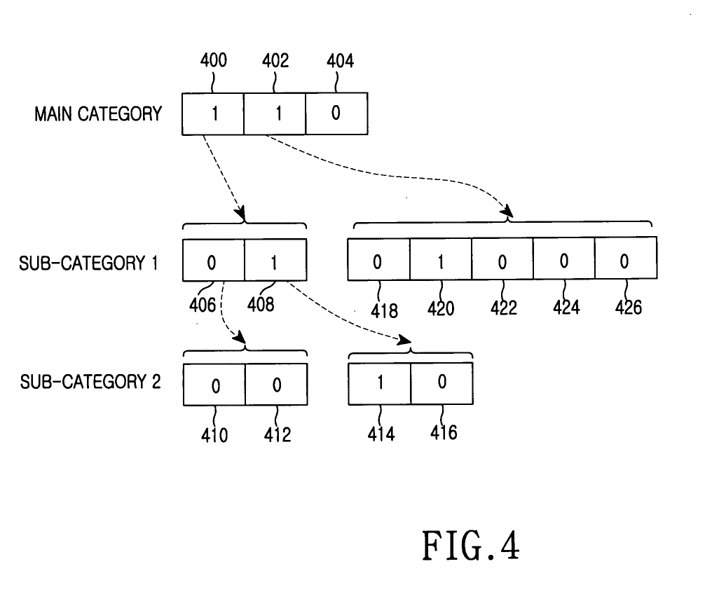

Taking the example illustrated in FIG. 4, the scheduling setting table has main category fields 400, 402 and 404 representing LCD Screen, Alert Type, and Roaming, respectively, in the Setting Group Registration menu (300). Sub-category 1 includes fields 406 and 408 representing Menu Style and Background Image for the LCD Screen menu (302), and fields 418, 420, 422, 424, and 426 representing Ring/Melody, Vibration, Silencing (Only Light), Ring+Vibra, and Vibra+Ring, respectively, for the Alert Type menu. Sub-category 2 includes fields 410 and 412 representing sub-menu options, for example, Round and Basic for Menu Style, and fields 414 and 416 representing Camera and Basic for Background Image (304).

Each of the main category fields and sub-category fields occupies 1 bit. Each field is set to logic 1 if a corresponding menu (menu option) is selected or to logic 0 if the menu (menu option) is not selected. From the scheduling setting table illustrated in FIG. 4, it is noted that the user has sequentially selected LCD Screen for Setting Group Registration, Background Image for LCD Screen, and Camera for Background Image, as well as Alert Type for Setting Group Registration, and Vibration for Alert Type.

As illustrated in FIGS. 3 and 4, user setting menus (menu options) available to the mobile terminal are arranged in the Setting Group Registration menu to make the mobile terminal easier to use. Furthermore, listing the user setting menus and menu options with their 1-bit setting values in the scheduling setting table illustrated in FIG. 4 minimizes the memory capacity that scheduling setting groups occupy. That is, since logic 1 is stored only for selected or set menus and menu options, a memory capacity requirement is remarkably reduced relative to a conventional method of storing setting values on a byte basis.

The user selects one of the registered scheduling setting groups, sets a scheduling timer, registers a timer value, and sets a scheduling setting mode. Alteration of the setting of the selected scheduling setting group is then activated. The scheduling timer allows the user to set timer values for changing the setting of the setting categories with logic Is. The scheduling timer can be, for example, an appointment timer, a length timer, a period timer, or a repetition timer. The appointment timer gives an alarm at a designated time. The length timer gives an alarm when a predetermined time elapses and the period timer informs the user of the start and end of a predetermined period. The repetition timer gives an alarm at every predetermined time interval. The alarm interval is set on a year, quarter of the year, month, or day basis. If the user wants to change the settings of the selected user setting menu options at a desired time every day, the repetition timer is used.

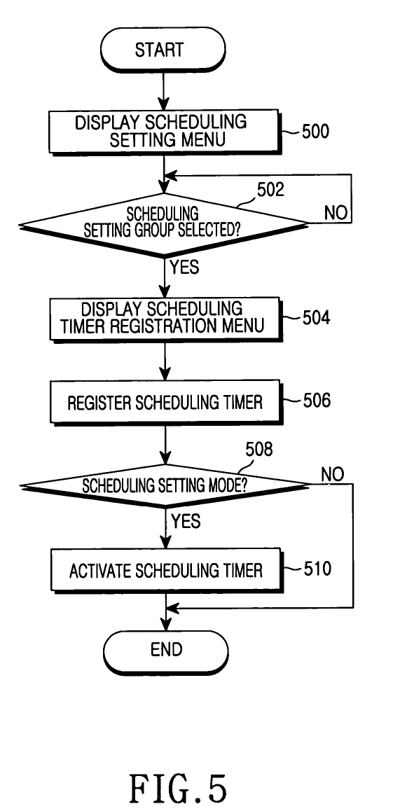

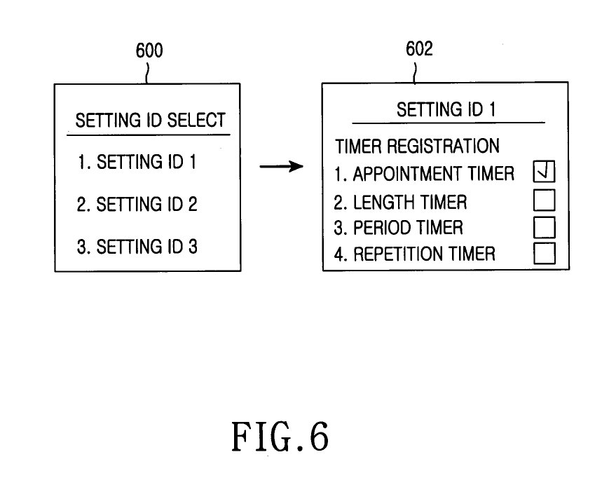

FIG. 5 is a flowchart illustrating an operation for setting a scheduling setting menu in the MPU 100 according to the present invention. Referring to FIG. 5, when the user selects the scheduling setting menu using the keypad 108, the MPU 100 displays the scheduling setting menu on the display 110 in step 500 and awaits selection of a scheduling setting group in step 502. The scheduling setting menu is added to the traditional menus provided in the mobile terminal according to the present invention. It is denoted by reference numeral 600 in FIG. 6. The scheduling setting menu 600 contains Setting ID 1, Setting ID 2, and Setting ID 3 indicating that three scheduling setting groups have been registered. If the user selects Setting ID 1, a display of a scheduling timer registration 602 is provided. In the Setting ID 1 menu, the user selects one of four timers to register a scheduling timer.

When the user selects one of the scheduling setting groups in the Scheduling Setting menu 600 using the keypad 108, the MPU 100 displays the Scheduling Timer Registration menu 602 in step 504. When the user selects at least one of the scheduling timers and sets a timing value for the selected scheduling timer(s), the MPU 100 registers the selected scheduling timer(s) with the timing value in step 506.

If the appointment timer is selected, the timer is set to a value indicating a desired time when the setting of a user setting menu option is to be changed. In the case of the length timer, the timer is set to a value indicating the time between the current time and a desired time when the setting of a user setting menu option is to be changed. If the period timer is selected, its timing value provides a start time when the setting of a user setting menu option is to be changed and an end time when the user setting menu option is be reset. If the repetition timer is selected, it is set to a desired time with an interval unit. In FIG. 6, the appointment timer is marked with “√” as a scheduling timer in the Scheduling Timer Registration menu 602, by way of example.

In step 508, the MPU 100 determines whether the user has set a scheduling setting mode. Here, a text message is displayed on the display 110, asking whether the scheduling setting mode is to be set or not. If the user wants to, he presses the Send key and if he doesn't, he presses the End key. In the former case, the MPU 100 activates the scheduling timer in step 510 and terminates this procedure. In the latter case, the MPU 100 directly terminates the procedure.

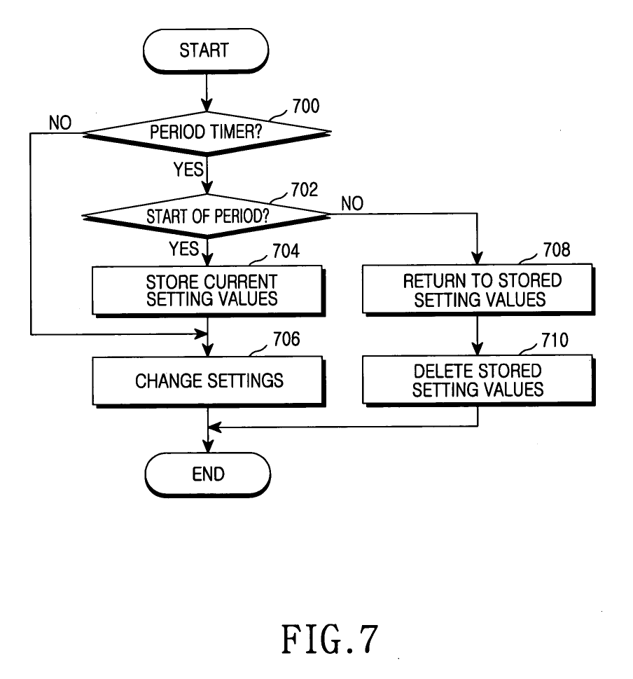

FIG. 7 is a flowchart illustrating an operation for changing the settings of user setting menu options as scheduled according to the present invention.

Referring to FIG. 7, after the scheduling timer is registered and the scheduling setting mode is set, the MPU 100 determines which type the scheduling timer is set in step 700. If it is a period timer, the MPU 100 proceeds to step 702. Otherwise, the MPU 100 jumps to step 706.

In step 706, the MPU 100 changes the settings of menu options corresponding to setting categories to their registered values, under a scheduling setting group which was set to the scheduling setting mode. Thus the settings of the menu options are changed at the time specified by the user.

In the case of a period timer, the MPU 100 determines whether the start time of the predetermined period has been reached in step 702, which can be discriminated using a flag. The flag is set at the start time of the period timer and reset at the end time. At the start time, the current setting values of the menu options are stored in the flash RAM 106 in step 704 and the MPU 100 proceeds to step 706. The stored setting values are used to return the menu options to their original states at the end time.

At the end time of the period timer the MPU 100 returns the menu options to the stored values in step 708 and deletes the stored values from the flash RAM 106 in step 710. Thus, the settings of menu options corresponding to the setting categories of a scheduling setting group in the scheduling setting mode are changed simultaneously at the start time of a predetermined period and returned to their original states at the end time.

In accordance with the present invention as described above, the user freely selects user setting menu options according to his variable schedule and registers them in different scheduling setting groups. He selects one of the scheduling setting groups, registers a scheduling timer for the selected scheduling setting group, and sets the selected scheduling setting group to a scheduling setting mode. Then the settings of the user setting menu options are automatically changed simultaneously at a desired time.

For example, if the user makes out a daily or monthly schedule and decides the settings of user setting menu options according to his schedule, the settings are changed automatically and simultaneously. Different scheduling setting groups are registered according to a variable schedule and a corresponding scheduling setting group is selected and set to a scheduling setting mode by simple manipulation if the schedule is changed. This obviates the need for individually setting each user setting menu option according to the changed schedule.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of changing the setting of user setting menu options in a mobile terminal, the user setting menu options being menu options which a user can set, comprising the steps of:
registering the user setting menu options selected by the user from among menu options available in the mobile terminal as setting categories in connection with set values selected by the user in a scheduling setting group;
setting a scheduling timer to a timing value for changing the settings of selected user setting menu options;
activating the scheduling timer when a scheduling setting mode is set; and
changing the user setting menu options to the set values of the setting categories upon expiration of the timing value of the scheduling timer.

2. The method of claim 1, wherein the scheduling timer is selected from the group of an appointment timer set at a first predetermined time, a length timer for timing when a second predetermined time elapses, a period timer for timing a predetermined period having start and end times, and a repetition timer for timing a predetermined time interval.

3. The method of claim 2, wherein the changing step further comprises the steps of:
storing the set values of the user setting menu options corresponding to the setting categories of the scheduling setting group at the start time of the predetermined period of the period timer;
changing the set values of the user setting menu options to the set values of the scheduling setting group; and
returning the user setting menu options to the stored set values when the end time of the predetermined period of the period timer is reached.

4. A method of changing the setting of user setting menu options in a mobile terminal, the user setting menu options being menu options which a user can set, comprising the steps of:
registering the user setting menu options selected by the user from among menu options available in the mobile terminal as setting categories in connection with set values selected by the user in a scheduling setting group having a unique identifier (ID);
setting a scheduling timer to a timing value for changing the settings of selected user setting menu options registered as setting categories in a scheduling setting group selected from at least one scheduling setting group;
activating the scheduling timer when a scheduling setting mode is set; and
changing the user setting menu options in the selected scheduling setting group to the set values of the setting categories upon expiration of the timing value of the scheduling timer.

5. The method of claim 4, wherein the scheduling timer is selected from the group of an appointment timer set at a first predetermined time, a length timer for timing when a second predetermined time elapses, a period timer for timing a predetermined period having start and end times, and a repetition timer for timing a predetermined time interval.

6. The method of claim 5, wherein the changing step further comprises the steps of:
storing the set values of the user setting menu options corresponding to the setting categories of the selected scheduling setting group at the start time of the predetermined period of the period timer;
changing the set values of the user setting menu options to the set values of the scheduling setting group; and
returning the user setting menu options to the stored set values when the end time of the predetermined period of the period timer is reached.
